(19) United States
(12) Patent Application Publication
(10) Pub. No.: US 2016/0207060 A1
(43) Pub. Date: Jul. 21, 2016

(54) Solar powered automatic control switch for sprayer hoses

(71) Applicant: Jame-San CHOU, NEW TAIPEI CITY (TW)

(72) Inventor: Jame-San CHOU, NEW TAIPEI CITY (TW)

(21) Appl. No.: 14/615,430

(22) Filed: Feb. 6, 2015

(30) Foreign Application Priority Data
Jan. 15, 2015 (CN) 201510019028.4

(51) Int. Cl. B05B 12/12; B05B 9/00

(52) U.S. Cl. CPC B05B 12/12; B05B 9/00

(57) ABSTRACT

A solar powered automatic control switch for sprayer hoses comprising a control box (1); a circuit board (2) and sensors are provided in the control box (1); a temperature and humidity sensor (21), an illumination sensor (22), Hall effect sensors (15) and a central control unit (23) are provided in the circuit board (2); the central control unit (23) is electronically connected with the temperature and humidity sensor (21), the illumination sensor (22) and the Hall effect sensors (15); the central control unit (23) is also electronically connected with a motor (3); the motor (3) is connected with a circular rotary valve (6); the circular rotary valve (6) is disposed internal to a cylindrical fixation base (7); two ends of the cylindrical fixation base (7) are each provided with a hose quick connector (8).

### BACKGROUND OF THE INVENTION

The present invention relates to a kind of control switch for a kind of water pipe, and more specifically relates to a solar powered automatic control switch for sprayer hoses.

In tropical, subtropical and temperate zones, summer heat is furious especially on sunny days where roof tops can be heated up to more than 50 degree Celsius. The furious heat seriously affects people's normal working and daily lives. By spraying water on the roof tops after sunset, the roof tops can be cooled down so that the use of air conditioning is significantly reduced in terms of time and strength. In increasing number of places such as farmlands, gardens and parks, large input of manpower is required daily for watering plants. However, due to gradually insufficient supply of workers and gradually higher cost of labor, a kind of sprayer device controlled by solenoid valve has emerged in the market. Yet, this kind of sprayer device requires arrangement of very long wires and cables. Another kind of sprayer system now available in the market uses dry cell to control the time periods in which spraying should be activated, but this kind of sprayer system is very expensive and not easy to control, and it also requires battery replacement and complicated installation procedures. Moreover, the above control devices now available in the market cannot automate spraying action based on temperature and sunlight.

### BRIEF SUMMARY OF THE INVENTION

In view of the aforesaid disadvantages now present in the prior art, the present invention provides a solar powered automatic control switch for sprayer hoses.

The present invention is attained as follows:

A solar powered automatic control switch for sprayer hoses comprising a control box; a circuit board and sensors are provided in the control box; a temperature and humidity sensor, an illumination sensor, Hall effect sensors and a central control unit are provided in the circuit board; the central control unit is electronically connected with the temperature and humidity sensor, the illumination sensor and the Hall effect sensors; the central control unit is also electronically connected with a motor; the motor is connected with a circular rotary valve; the circular rotary valve is disposed internal to a cylindrical fixation base; two ends of the cylindrical fixation base are each provided with a hose quick connector.

A drive gear is provided on the motor; the drive gear drives a driven gear; the driven gear is provided with small gear teeth which drive a step down gear; the step down gear is connected to the circular rotary valve.

An outer upper part of the control box is provided with a solar panel; the solar panel is electrically connected to a battery; the battery supplies power to the circuit board.

An outer side of the step down gear is provided with a shaft fixation plate.

An outer side of the control box is provided with a protective cover; the protective cover is connected with the control box via screw threads; a water proof ring is provided between the protective cover and the control box.

A bottom end of the control box is connected with a disc shaped base.

The present invention has the following advantages:

The present invention has great adaptability. It can be quickly and conveniently installed to directly connect with water pipes in anywhere that is provided with water supply. It can also operate in anywhere that is exposed to sunlight. It will automatically spray water when the conditions for spraying are met and does not require frequent manual on/off operation. When ambient humidity returns to normal, the present invention will be automatically turned off without the need of manual operation to turn off. Therefore, the present invention can essentially save the cost of labor. Further, the present invention can prevent wastage of water due to delayed manual turn off operation of some sprayers when there are a great number of sprayers to be turned off at the same time. Since the present invention uses solar power supply system, thereby saving the trouble of connecting wires and cables, the cost can be further reduced. The present invention is also equipped with intelligent control system so that it can determine whether spraying is required or not according to environmental data. As such, crops, plants and trees can grow in exceptionally good environments thanks to the realization of automatic activation and deactivation of spraying action.

### BRIEF DESCRIPTION OF THE DRAWINGS

FIG. 1 illustrates the structure of a solar powered automatic control switch for sprayer hoses according to the present invention.

### REFERENCE SIGNS IN THE FIGURE

| | | | |
|---|---|---|---|
| 1: | control box | 2: | circuit board |
| 21: | temperature and humidity sensor | 22: | illumination sensor |
| 23: | central control unit | 3: | motor |
| 31: | drive gear | 4: | driven gear |
| 41: | small gear teeth | 5: | step down gear |
| 6: | circular rotary valve | 7: | cylindrical fixation base |
| 8: | hose quick connector | 9: | battery |
| 10: | solar panel | 11: | shaft fixation plate |
| 12: | water proof ring | 13: | protective cover |
| 15: | Hall effect sensor | | |

### DETAILED DESCRIPTION OF THE INVENTION

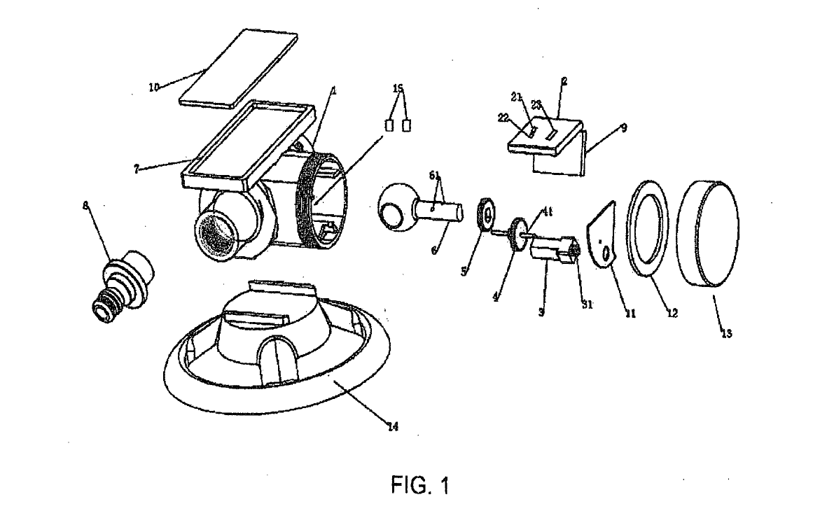

The present invention is described further in detail below with reference to FIG. 1.

As shown in FIG. 1, the solar powered automatic control switch for sprayer hoses according to the present invention comprises a control box 1; a circuit board 2 and Hall effect sensors 15 are provided in the control box 1; a temperature and humidity sensor 21 for sensing ambient temperature and humidity, an illumination sensor 22 for detecting daily illumination, and a central control unit 23 for processing signals transmitted from the temperature and humidity sensor 21 and the illumination sensor 22 and sending the processed signals to a motor 3 are provided in the circuit board 2; a drive gear 31 is provided on the motor 3; the drive gear 31 drives a driven gear 4; the driven gear 4 is provided with small gear teeth 41 which drive a step down gear 5; the step down gear 5 is connected to a circular rotary valve 6; four magnets are provided on a rotation shaft of the circular rotary valve 6; the circular rotary valve 6 is disposed internal to a cylindrical fixation base 7; two ends of the cylindrical fixation base 7 are each provided with a hose quick connector 8.

An outer upper surface of the control box 1 is provided with a solar panel 10; the solar panel 10 is electrically connected to a battery 9; the battery 9 supplies power to the circuit board 2; an outer side of the step down gear 5 is provided with a shaft fixation plate 11 for positioning the step down gear 5; an outer side of the control box 1 is provided with a protective cover 13; the protective cover 13 is connected with the control box 1 via screw threads; a water proof ring 12 is provided between the protective cover 13 and the control box 1; the water proof ring 12 serves the purpose of water proof; a bottom end of the control box 1 is provided with a disc shaped base 14 for supporting the present invention; the disc shaped base 14 is separable. The present invention has an automatic detection system to automatically detect accumulative illumination from the sun. When illumination from the sun is accumulated up to more than 3-4 hours, the system will be automatically turned on; when illumination from the sun drops below a predetermined value indicating sunset, the system determines that water can be sprayed; after that, the system also checks temperature and humidity; if all these three parameters meet the required conditions, spraying action should be activated.

The temperature and humidity sensor 21 senses current ambient temperature and humidity; when the ambient temperature is higher than a set value indicating high temperature, a first spraying condition A is determined to be met; when the ambient humidity is lower than a set value indicating no rain, a second spraying condition B is determined to be met.

When all the parameters meet the required conditions for spraying water, the central control unit 23 supplies power to the motor 3; the motor 3 drives the circular rotary valve 6 to move a quarter circle per time to activate spraying action.

The solar powered automatic control switch for sprayer hoses according to the present invention can also be implemented to control other water pipe control systems apart from the described implementation. The present invention adopts a water proof structure so that the entire device is water proof. The present invention also uses heat resistant and sunlight blocking materials and it can be implemented in sewage water system.

The present invention has a disc shaped supporting base, but other supporting bases may also be used. The disc shaped supporting base is suitable to be used in many places such as yards, green fields, lawns, farmlands and hillsides etc. Supporting bases of other shapes can be used on roof tops and beams etc. The supporting base helps realize automatic activation and deactivation of spraying action.

Although the present invention is explained and embodied in a relatively detailed manner according to the above description, it should be understood that any changes or any equivalent alternatives in lieu of the described embodiment should be obvious to a person skilled in this field of art. Therefore, any changes or modifications made without deviating from the spirit of the present invention should also fall within the scope of protection of the present invention.

What is claimed is:

1. A solar powered automatic control switch for sprayer hoses comprising a control box (1); a circuit board (2) and sensors are provided in the control box (1); a temperature and humidity sensor (21), an illumination sensor (22), Hall effect sensors (15) and a central control unit (23) are provided in the circuit board (2); the central control unit (23) is electronically connected with the temperature and humidity sensor (21), the illumination sensor (22) and the Hall effect sensors (15); the central control unit (23) is also electronically connected with a motor (3); the motor (3) is connected with a circular rotary valve (6); the circular rotary valve (6) is disposed internal to a cylindrical fixation base (7); two ends of the cylindrical fixation base (7) are each provided with a hose quick connector (8).

2. The solar powered automatic control switch for sprayer hoses as in claim 1, wherein a drive gear (31) is provided on the motor (3); the drive gear (31) drives a driven gear (4); the driven gear (4) is provided with small gear teeth (41) which drive a step down gear (5); the step down gear (5) is connected to the circular rotary valve (6).

3. The solar powered automatic control switch for sprayer hoses as in claim 1, wherein an outer upper part of the control box (1) is provided with a solar panel (10); the solar panel (10) is electrically connected to a battery (9); the battery (9) supplies power to the circuit board (2).

4. The solar powered automatic control switch for sprayer hoses as in claim 1, wherein an outer side of the step down gear (5) is provided with a shaft fixation plate (11).

5. The solar powered automatic control switch for sprayer hoses as in claim 1, wherein an outer side of the control box (1) is provided with a protective cover (13); the protective cover (13) is connected with the control box (1) via screw threads; a water proof ring (12) is provided between the protective cover (13) and the control box (1).

6. The solar powered automatic control switch for sprayer hoses as in claim 1, wherein a bottom end of the control box (1) is connected with a disc shaped base (14).
